(19) United States
(12) Patent Application Publication
(10) Pub. No.: US 2024/0402127 A1
(43) Pub. Date: Dec. 5, 2024

(54) MULTI SENSING APPROACH FOR INDUSTRIAL INSPECTION

(71) Applicant: Baker Hughes Holdings LLC, Houston, TX (US)

(72) Inventors: Giovanni Canni, North Tyneside (GB); Jeffrey Earle Sutherland, Calgary (CA)

(21) Appl. No.: 18/667,292

(22) Filed: May 17, 2024

Related U.S. Application Data
(60) Provisional application No. 63/470,007, filed on May 31, 2023.

(51) Int. Cl. G01N 27/90; G01M 3/00; G01M 3/40; G01N 27/72

(52) U.S. Cl. CPC G01N 27/90; G01M 3/005; G01M 3/40; G01N 27/725

(57) ABSTRACT

An inspection system for performing multi-sensing inspection of a specimen is provided. The inspection system includes an inspection apparatus arranged to acquire at least stress data characterizing stress on a specimen being inspected at a plurality of points along the specimen, NDE data characterizing flaws within the specimen and dimensional properties of the specimen at the plurality of points along the specimen and positional data characterizing a location of the plurality of points along the specimen. The system also includes a computing system including at least one data processor and a memory storing instructions which can cause the at least one data processor to perform operations including: receiving the stress data, the NDE data and the positional data, generating a comprehensive representation of the specimen and providing the comprehensive representation to a user interface display communicatively coupled to the computing system.

### RELATED APPLICATION

This application claims priority under 35 U.S.C. § 119 (e) to U.S. Provisional Application No. 63/470,007 filed May 31, 2023, the entire contents of which are hereby expressly incorporated by reference herein.

### FIELD

The subject matter herein relates to systems and methods for combining a plurality of non-destructive inspection techniques to provide accurate characterizations of flaws and localized stresses specimen being inspected.

### BACKGROUND

Traditional methods of non-destructive examination (NDE), specifically internal systems for active pipelines (known as Inline Inspection (ILI) systems), are capable of identifying flaws (e.g., cracks) in the system by acquiring NDE measurements from one or more NDE techniques configured on the ILI tools, analyzing the data acquired, and predicting, from the analysis, a size and/or an extent of any flaws detected in the system being inspected. However, these systems and methods are designed to generate geometric predictions, and do not provide direct insights into other important parameters that are vital to determining the integrity of a specimen under inspection, such as the stress on the specimen as a result of various forms of internal and external loading on the pipeline. Further, conventional systems and methods of measuring stress/strain in a specimen (e.g., pipes as structures within a pipeline system) under inspection assess the threat of a given flaw in isolation, or as it pertains to other (geometrically) interacting flaws.

Further, conventionally axial strain in specimen being inspected is estimated using strain gauges or by making cut-outs from the section under investigation, which can have inaccuracies and can require time and cost intensive lab work. Furthermore, while mounted sensors, such as strain gauges, measure axial strain starting from the time of installation on the pipeline, they are very localized to the area of installation and do not provide insights into overall areas of increased axial strain through the life of the pipeline specimen, including insights to residual stresses and strains existing from original manufacturing. Conventional assessment methods also assume an ambient mechanical stress field, which can have inaccuracies and can overlook changes in stress on the specimen at different points.

On the other hand some conventional eddy current NDE technique based systems are designed to estimate stress in ferrous objects but have limited accuracy and application due to their localization and lack of capability to fully characterize the geometry of the specimen for the full scale length of a pipeline system.

### SUMMARY

In one aspect, an inspection system for performing multi-sensing inspection of a specimen is provided. In some aspects, the inspection system can include an inspection apparatus arranged to inspect a specimen, the inspection apparatus including a plurality of non-destructive examination (NDE) units arranged to acquire at least stress data characterizing stress on the specimen at a plurality of points along the specimen, NDE data characterizing flaws within the specimen and dimensional properties of the specimen at the plurality of points along the specimen and positional data characterizing a location of the plurality of points along the specimen. The inspection system also includes a computing system including at least one data processor and a memory storing computer-readable instructions which, when executed by the at least one data processor, can cause the at least one data processor to perform operations including: receiving, from the inspection apparatus, the stress data, the NDE data and the positional data, generating a comprehensive representation of the specimen, wherein the comprehensive representation includes an overlay of the stress data, the NDE data and the positional data at the of the plurality of points and providing the comprehensive representation to a user interface display communicatively coupled to the computing system.

In some aspects, the specimen can be a pipeline made from a ferromagnetic material. In some aspects, the plurality of NDE units include a stress measurement unit including a plurality of magnetic probes and the stress data includes stress measurements acquired at a plurality of angles for each of the plurality of points along the specimen.

In some aspects, the flaws can include defects, areas of volumetric material loss, cracks and dents within the pipeline and the dimensional properties can include a shape of the pipeline at the plurality of points, and the NDE data can further include data characterizing localized materials properties of the pipeline.

In some aspects, the plurality of NDE units can further include one or more of an ultrasonic transducer unit, a radiography unit, an electromagnetic acoustic transducer (EMAT) unit, an eddy current probe unit, a magnetic flux leakage (MFL) unit, a caliper unit, a camera unit, an encoder unit and an inertial measurement unit (IMU).

In some aspects, the positional data can include first positional data, acquired by the encoder unit, and characterizing a position of the plurality of points within the pipeline and second positional data, acquired by the IMU, and characterizing a position of the plurality of points in three-dimensional space.

In some aspects, the operations performed by the at least one data processor can further include: determining one or more areas of interest within the pipeline based on the comprehensive representation, wherein the one or more areas of interest correspond to one or more points of the plurality of points that exhibit one or more of a high stress or a flaw and providing the one or more areas of interest to the user interface display.

In some aspects, the operations performed by the at least one data processor can further include: determining one or more maximum allowable operating pressures for the pipeline based on the one or more areas of interest and providing the one or more maximum allowable operating pressures to the user interface display.

In some aspects, the memory can further store historical data characterizing one or more past inspections of the pipeline. In this case, the operations performed by the at least one data processor can further include: comparing the comprehensive representation to the historical data, determining one or more dynamic areas of interest within the pipeline based on the comparison, wherein the one or more dynamic areas of interest correspond to one or more points of the plurality of points along the pipeline that exhibit changes in one or more of the stress data, the NDE data and the positional data over time and providing the one or more dynamic areas of interest to the user interface display.

In some aspects, the operations performed by the at least one data processor can further include: predicting one or more future maximum allowable operating pressures for the pipeline for a given point in time based on the one or more dynamic areas of interest and providing the one or more future maximum allowable operating pressures to the user interface display.

In some aspects, the operations performed by the at least one data processor further include: determining a potential geohazard threat based on the one or more dynamic areas of interest, wherein the potential geohazard threat is determined based on changes in the positional data over time and providing a notification to the user interface display indicative of the potential geohazard threat and the positional data corresponding to the potential geohazard.

In some aspects, the inspection apparatus can be an in-line inspection (ILI) unit arranged to move along the pipeline during the inspection.

In another aspect, a method of performing a multi-sensing inspection of a specimen is provided. In some aspects, the method can include receiving, by a computing system including at least one data processor and a memory storing computer-readable instructions, from an inspection apparatus, stress data characterizing stress at a plurality of points of a specimen being inspected, non-destructive examination (NDE) data characterizing flaws within the specimen and dimensional properties of the specimen at the plurality of points and positional data characterizing a location of the plurality of points the specimen. The method can also include generating, by the at least one data processor, a comprehensive representation of the specimen, wherein the comprehensive representation includes an overlay of the stress data, the NDE data and the positional data at the of the plurality of points and providing, by the at least one data processor, the comprehensive representation to a user interface display communicatively coupled to the computing system.

In some aspects, the specimen can be a pipeline made from a ferromagnetic material and the inspection apparatus can be an in-line inspection unit. In this case, the method can further including deploying the in-line inspection unit within the pipeline to perform the inspection. In some aspects, the in-line inspection unit can include a stress measurement unit arranged to acquire the stress data and one or more NDE units arranged to acquire the NDE data and the positional data.

In some aspects, the one or more NDE measurement units can include one or more of an ultrasonic transducer unit, a radiography unit, an electromagnetic acoustic transducer (EMAT) unit, an eddy current probe unit, a magnetic flux leakage (MFL) unit, a caliper unit and a camera unit, and the flaws can include one or more of defects, areas of volumetric material loss, cracks and dents within the pipeline and the dimensional properties can include a shape of the pipeline at the plurality of points, and the NDE data can further include data characterizing localized materials properties of the pipeline.

In some aspects, the one or more NDE measurement units can include an encoder and an inertial measurement unit (IMU). In this case, the method can further include acquiring, by the encoder, first positional data characterizing a position of the plurality of points within the pipeline and acquiring, by the IMU, second positional data characterizing a position of the plurality of points in three-dimensional space.

In some aspects, the method can further include: determining, by the at least one data processor, one or more areas of interest within the pipeline based on the comprehensive representation, wherein the one or more areas of interest correspond to one or more points of the plurality of points that exhibit one or more of a high stress or a flaw and providing, by the at least one data processor, the one or more areas of interest to the user interface display.

In some aspects, the method can further include: determining, by the at least one data processor, one or more maximum allowable operating pressures for the pipeline based on the one or more areas of interest and providing, by the at least one data processor, the one or more maximum allowable operating pressures to the user interface display.

In some aspects, the memory can further store historical data characterizing one or more past inspections of the pipeline. In this case, the method can further include: comparing, by the at least one data processor, the comprehensive representation to the historical data, determining, by the at least one data processor, one or more dynamic areas of interest within the pipeline based on the comparison, wherein the one or more dynamic areas of interest correspond to one or more points of the plurality of points along the pipeline that exhibit changes in one or more of the stress data, the NDE data and the positional data over time and providing, by the at least one data processor, the one or more dynamic areas of interest to the user interface display.

In some aspects, the method can further include: predicting, by the at least one data processor, one or more future maximum allowable operating pressures for the pipeline for a given point in time based on the one or more dynamic areas of interest and providing, by the at least one data processor, the one or more future maximum allowable operating pressures to the user interface display.

In some aspects, the method can further include: determining, by the at least one data processor, a potential geohazard threat based on the one or more dynamic areas of interest, wherein the potential geohazard threat is determined based on changes in the positional data over time and providing, by the at least one data processor a notification to the user interface display indicative of the potential geohazard threat and the positional data corresponding to the potential geohazard.

### BRIEF DESCRIPTION OF THE DRAWINGS

These and other features will be more readily understood from the following detailed description taken in conjunction with the accompanying drawings, in which:

FIG. 1 is a diagram illustrating an exemplary embodiment of a multi-sensing inspection system according to the subject matter described herein;

FIG. 2 illustrates a method of inspecting a specimen (e.g., a pipeline) using the inspections system of FIG. 1;

FIG. 3 illustrates a dynamic method of inspecting a specimen (e.g., a pipeline) over time using the inspections system of FIG. 1;

FIG. 4 is an exemplary comprehensive model/representation of a specimen being inspected using the systems and methods described herein which can be provided to a user interface display;

FIG. 5 illustrates exemplary renderings of a cross-sectional view and internal surface view, respectively, of a section of the pipeline that includes a flaw on an internal surface thereof, which can be used, in combination with the time, stress, geometrical, positional and material property data to determine a desired safe operating pressure for the section of the pipeline;

FIG. 6 illustrates exemplary renderings of a cross-sectional view and internal surface view, respectively, of a section of the pipeline that includes a flaw on an external surface thereof, which can be used, in combination with predictive models, time, stress, geometrical, positional and material property data and to determine a desired safe operating pressure for the section of the pipeline;

FIG. 7 is a block diagram of a computing system suitable for use in implementing the computerized components of the system of FIG. 1 according to the subject matter described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Traditional methods of non-destructive examination (NDE), specifically for pipeline systems, are capable of identifying flaws (e.g., cracks) in the system by acquiring NDE measurements from one or more NDE tools, analyzing the data acquired, and predicting, from the analysis, a size and/or an extent of any flaws detected in the system being inspected. However, the predicted estimations from these systems and methods are catered to geometric flaws of interest, and do not provide full insight into other important parameters that can be vital to determining the integrity of a specimen under inspection, such as the stress on the specimen as a result of various forms of loading. Further, conventional systems and methods of measuring stress/strain in specimen (e.g., a pipeline system) under inspection assess a threat of a given flaw in isolation, or as it pertains to other interacting flaws. Further, conventionally axial strain in specimen being inspected may be estimated using strain gauges or by making cut-outs from the section under investigation, which can have inaccuracies and can require time and cost intensive lab work. Furthermore, while strain gauges measure strain starting from the time of installation on the pipeline, they are localized and may not provide insights into areas of increased axial strain through the length and lifecycle of the specimen, including those residual stress and strains produced during manufacturing. Conventional assessment methods also assume ambient mechanical stress field, which can have inaccuracies and can overlook changes in stress on the specimen at different points. On the other hand, conventional eddy current NDE technique based systems that are designed to estimate stress in ferrous objects can have limited accuracy due to their lack of capability to characterize the geometry and distribution of flaws within the specimen.

The systems and methods described herein address the aforementioned shortcomings by providing a system capable of accurately characterizing geometries of features/flaws within a specimen, while also providing a comprehensive characterization of the stress/strain state within the specimen. In some aspects, the system can include one or more NDE techniques from one or more inspection tools used to in geometric flaw prediction configured to acquire a plurality of measurements of the specimen in conjunction with a stress measurement NDE technique configured to provide time and position correlated data characterizing the stress/strain of the specimen. For example, in some aspects, geometric NDE techniques for pipelines can include magnetic flux leakage (MFL) tools to enable the identification of volumetric features which can act as stress concentrators as well as electromagnetic tools (e.g., eddy current sensors) to obtain an accurate estimation of localized stress. In some aspects, the stress measurement method can include a Magnetic Anisotropy and Permeability System (MAPS) including a plurality of probes, each having particularly arranged sensors arranged to acquire a series of measurements of a specimen (e.g., a pipe) at a series of positions along the specimen. In some aspects, the systems and method provided herein can compile and assess for a level of fitness for service of the item under inspection through a combination of data from the above referenced techniques, and use pre-established safety factors or acceptability criteria for fitness for service, to determine potential for failure. In some aspects, the systems and methods provided herein can also characterize and distinguish a potential injurious threat as from stress/strain loads on the pipeline. The systems and method provided herein can also characterize and distinguish potentially injurious stress/strain resulting from a flaw itself, or a potentially injurious stress/strain from loads and flaws together. The systems and method provided herein can further generate a condition assessment from all sources of loading and from all detectable flaws and/or unintended structural conditions to produce calculated data sets as a physical structural model and as a continuous predicted stress/strain state(s) for all locations on a pipeline specimen. In some aspects, a predicted physical structural model and predicted stress/strain state(s) can include current and future states.

In some aspects, the systems and methods described herein can be implemented in in-line inspection (ILI) of pipeline systems, as discussed in greater detail below. In some aspects, a combination of various NDE techniques can be used to develop a comprehensive model of the pipeline being inspected. For example, the various NDE techniques can include, but are not limited to, stress measurement techniques configured to acquire stress data including characterizing stress within a pipe wall of a pipeline, inspection techniques configured to acquire data for characterizing flaws within the pipeline and techniques to determine dimensional properties of the pipeline at the plurality of points along the specimen. Additional NDE techniques can include positional measurement techniques configured to acquire positional data characterizing a location of the plurality of points along the pipeline. In some aspects, stress measurement units can include a plurality of probes configured to acquire the stress data of the specimen. In some aspects, flaw measurement units can include ultrasonic transducer units, radiography units, electromagnetic acoustic transducer (EMAT) units, eddy current probes, caliper units and camera units to variously determine flaws and other geometrical properties within the specimen including, for example defects, areas of volumetric material loss, cracks, dents and shape/changes in shape of the specimen. In some aspects, the positional measurement units can include encoders to acquire data characterizing a position within the specimen (e.g., a distance traveled within a pipeline) and inertial measurement units to acquire data characterizing a position of the specimen in three-dimensional space.

Advantageously, the systems and methods described herein are capable of providing a more comprehensive and accurate localized stress profile within a specimen that is provided by conventional systems and methods. The systems and methods described herein also advantageously improve determinations of a maximum allowable pressure (MAOP) in pipeline systems by removing the need to make unnecessary assumptions regarding the stresses on the system, as described in greater detail below. Additionally, by implementing the systems and methods described herein in ILI, a user can advantageously mitigate severe axial strains before they develop, by monitoring the stresses, flaws, shapes and position of the pipeline as they change over time, as discussed in greater detail below.

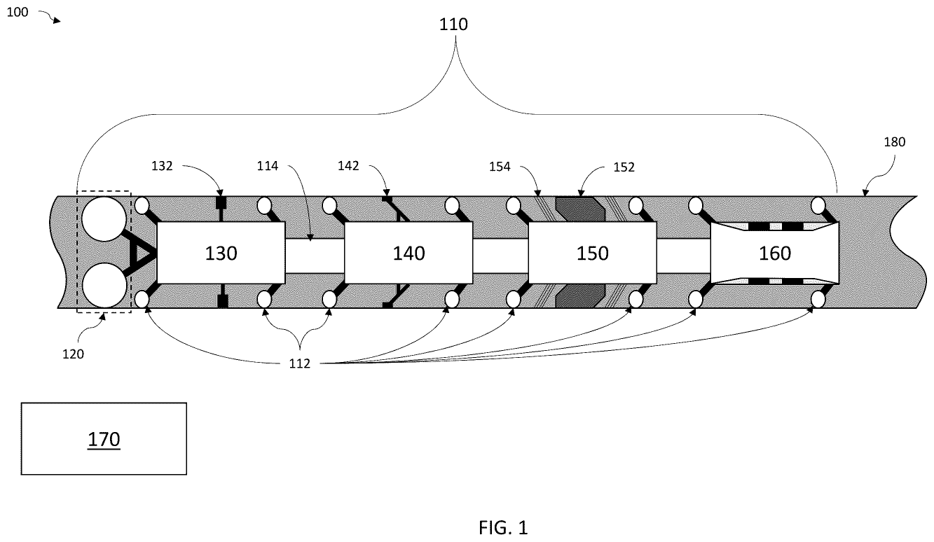

FIG. 1 illustrates an exemplary embodiment of a multi-sensing inspection system 100 according to the subject matter described herein. In some aspects, the system 100 can include an inspection apparatus 110 that is configured to carry out comprehensive inspections of pipeline systems (e.g., pipeline 180, as shown in FIG. 1). In some aspects, the inspection apparatus 110 can be an in-line inspection (ILI) tool which can include a navigation system 112 (e.g., a plurality of wheels configured to move the inspection apparatus 110 along the pipeline 180). In some aspects, the inspection apparatus 110 can also include a hub 114 which can include one or more computing systems (not shown) including a memory configured to store inspection data and computer readable instructions and at least one data processor configured to perform operations, as described in greater detail below. The inspection apparatus 110 can also include a plurality of non-destructive examination (NDE) tools/units 120, 130, 140, 150, 160 configured to acquire a plurality of measurements of a specimen being inspected. In some aspects, each of the plurality NDE tools/units, as described below, can be coupled by the hub 144 and configured transmit inspection data to the one or more computing systems of the hub 114 during an inspection to be stored/processed.

For example, as shown in FIG. 1, the inspection apparatus 110 can include a positional encoder unit 120 configured to acquire positional data characterizing a position of the inspection apparatus 110 within the pipeline (e.g., a distance that the inspection apparatus 110 has moved within the pipeline). The inspection apparatus 110 can also include a caliper unit 130 including a plurality of calipers 132 configured to acquire dimensional data characterizing a shape of the pipeline 180 (e.g., roundness) as the inspection unit 110 performs an inspection. The inspection apparatus 110 can also include one or more transducer units 140 including a plurality of probes 142. For example, in some aspects the one or more transducer units 140 can include one or more of ultrasonic transducers, electromagnetic acoustic transducers (EMAT) and eddy current transducers configured to detect flaws or changes in material properties within the specimen. In some aspects, the plurality of probes 142 can include phased array transducers.

The inspection apparatus 110 can also include a stress measurement unit 150. In some aspects, the stress sensing unit 150 can be a Magnetic Flux Leakage (MFL) unit and/or a Magnetic Anisotropy and Permeability System (MAPS), or other stress sensing unit configured to acquire data characterizing stress within the pipeline 180. For example, in some aspects, the stress measurement unit 150 can include a plurality of probes 152, each having particularly arranged magnetic sensors (e.g., arranged at different angles) and configured to acquire a series of measurements of a specimen (e.g., a pipe) at a series of positions along the specimen. The stress measurement unit 150 can also include metal brushes 154 configured to complete a magnetic circuit between the inspection apparatus 110 and the pipeline 180 made from a ferromagnetic material. Accordingly, in some aspects, the brushes 154 can be made from steel or the like.

The inspection apparatus 110 can also include an inertial measurement unit (IMU) 160 configured to acquire data characterizing one or more of accelerations, angular rates and magnetic fields which can be used to determine a position of the inspection apparatus in three-dimensional space. For example, in some aspects, the IMU 160 can include accelerometers configured to measure the acceleration forces acting on the inspection apparatus 110 along its different axes (usually X, Y, and Z) as well as changes in orientation. In some aspects, the IMU 160 can include gyroscopes configured to measure the angular rate or rotational velocity around each axis or magnetometers configured to measure an orientation of the inspection apparatus 110 relative to the Earth's magnetic field. While the inspection apparatus 110 is shown to include all of the plurality of NDE tools/units 120-160 arranged in the order as shown in FIG. 1, it should be noted that the inspection apparatus 110 can include any combination of one or more of the NDE tools/units 120-160 and they can be arranged in any order based on design preference.

As shown in FIG. 1, the inspection system 100 can also include a computing device 170. The computing device 170 can be configured to receive the inspection data acquired by the inspection apparatus 110 (e.g., from the computing system thereof) and analyze the inspection data to determine/predict areas of interest within the specimen based on stress and flaws experienced by the specimen and/or external factors, as will be described in greater detail below.

Traditional methods of inspecting pipeline systems can include acquiring geometrical NDE measurements of the pipeline and analyzing the data to determine and predict the geometries of flaws within the pipeline. However, these traditional methods that provide flaw representations are geometric characteristics, and do not provide insight into parameters such as material properties, stress and shape of the specimen, as they lack the ability to determine these parameters for different sections of the pipeline. Accordingly, the traditional methods require significant assumptions to be made regarding the material/material properties of the pipe (e.g., yield strength, strength curve, toughness/ductility, ultimate strength, etc.), the loads (internal and external loads) experienced by the pipeline at a given location and the shape of the pipe (e.g., assuming that the pipe is perfectly round at all points). Because the material properties, loads and shape of the pipe can very along the pipeline and can change over time, representations generated by these traditional methods can be incomplete and require significant safety factors to be built into the representations to compensate for these assumptions.

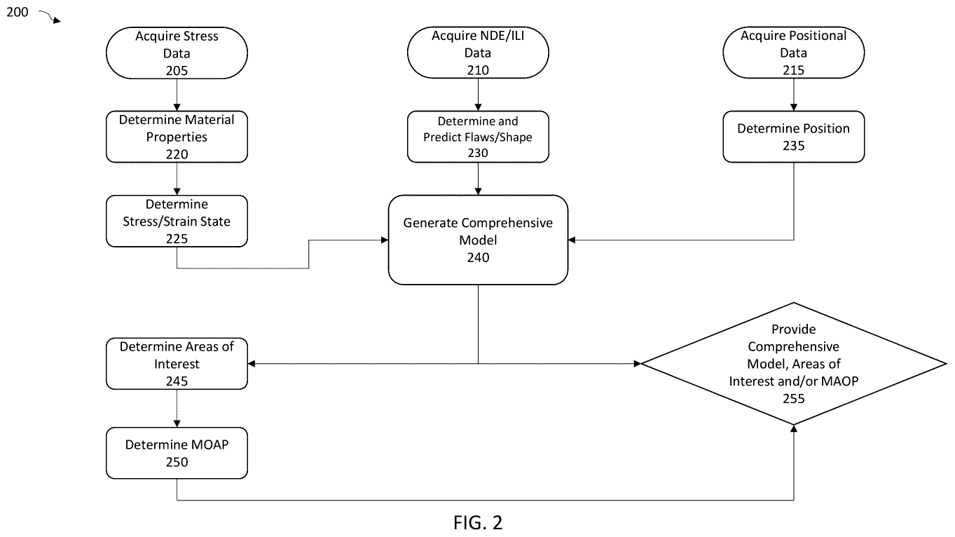

In order to accurately predict the threat of a given flaw, it would be desirable to know the material properties of the specimen being inspected at the location of the flaw, the stresses on the specimen at the location of the flaw, as well as the overall shape of the specimen at the location of the flaw and how any of these factors are changing over time. Accordingly, FIG. 2 illustrates a method 200 of inspecting a specimen (e.g., a pipeline) according using the inspections systems described herein (e.g., inspection system 100 of FIG. 1). The method 200 will be described herein with reference made to the inspection system of FIG. 1.

In some aspects, the method 200 can include steps 205-215 of acquiring NDE measurements of a specimen (e.g., pipeline 180) using one or more NDE tools/units 120-160. Specifically, the method 200 can include a step 205 of acquiring stress data from a stress measurement unit 150, a step 210 of acquiring NDE/ILI data from a caliper unit 130 and/or one or more transducer units 140, and a step 215 of acquiring positional data from an encoder 120 and/or an IMU 160.

In some aspects, the method 200 can further include steps 220-235 of analyzing the data acquired and determining material properties for a plurality of points along the specimen, stress/strain states of the specimen, flaws within the specimen, a shape of the specimen at the plurality of points, a distance that the inspection apparatus 110 has travelled within the specimen and three-dimensional positions of the plurality of points along the specimen.

Specifically, step 220 can include determining, by the computing system 170 and/or the computing system provided in the hub 114, material properties for the plurality of points within the pipeline. In some aspects, step 220 can be executed by comparing the stress data acquired by the stress measurement unit 150 to a library of calibration data representative of a plurality of predetermined stress responses for a plurality of pipe materials stored within the memory of the computing system. Based on the comparing, the system can either determine a material of the pipe, or interpolated material properties of the pipe in a case where the material was previously unknown and the stress data acquired by the stress measurement unit 150 does not directly match a pipe material of the plurality of pipe materials.

At step 225, the system can be configured to determine the stress/strain experienced by the pipeline at the plurality of points based on the stress data acquired by the stress measurement unit 150 and the material properties determined at step 220. In some aspects, the determined stress/strain can include an axial stress and a circumferential stress for each of the plurality of points along the portion of the pipeline being inspected, as well as the principal stress axes for the stress (e.g., in a case where the principal axes are not exactly parallel to the axial and circumferential directions. In some cases, the library of predetermined calibration data used in step 220 can further include a variety of stress and strain data specific to the plurality of pipe materials, for example, in the form of stress maps and/or diagnostic plots. Accordingly, the method described herein is also capable of providing a user with an accurate determination of the stress at continuous points within the specimen. However, in some cases, the material/material properties of the pipeline may already be known by a user. In this case, the system can be configured to bypass the step 220 and move directly to step 225 to determine the stress/strain experienced by the pipeline at the plurality of points based on the stress data acquired by the stress measurement unit 150 and the known material properties.

The step 230 can include determining, by the computing system 170 and/or the computing system provided in the hub 114, dimensional data characterizing a shape of the pipe (e.g., roundness) as the inspection unit 110 performs an inspection and flaws within the pipeline (e.g., areas of volumetric material loss, cracks, dents, etc.). In some aspects, the step 230 can be executed by analyzing the NDE data acquired by the caliper unit 130 and the one or more transducer units 140. However, in a case where the inspection apparatus 110 does not include a caliper unit 130, the system can be configured to determine the shape of the pipe based on a predetermined assumed shape.

The step 235 can include determining, by the computing system 170 and/or the computing system provided in the hub 114, positional data characterizing a position of the inspection apparatus 110. For example, in some aspects, the step 235 can include determining a position of the inspection apparatus 110 within the pipeline (e.g., a distance that the inspection apparatus 110 has moved within the pipeline) based on data received by the positional encoder unit 120. Additionally, the step 235 can include determining a position of the inspection apparatus 110 in three-dimensional space based on data received by the IMU 160.

The method 200 can further include a step 240 of generating, by the computing system 170, a comprehensive model/representation of the pipeline based on the stress data, the NDE data and the positional data determined at steps 225-235. In some aspects, the comprehensive representation can include an overlay of the stress data, the geometrical flaw data and the positional data at the of the plurality of points. The comprehensive representation can allow for a user to intuitively visualize the stresses and flaws within the pipeline and the areas in which the stresses and flaws overlap.

The method 200 can further include a step 245 of determining one or more areas of interest within the pipeline based on the comprehensive model/representation generated at step 240. For example, in some aspects, at step 245, the system can be configured to analyze areas of critical stress, areas indicating critical flaws, areas of unexpected shape and/or areas where stress, flaws and or changes in shape coincide in order to determine one or more areas of interest to be flagged by the system. In some aspects, the one or more areas of interest can also include determinations of one or more potential breakages and one or more predictions characterizing a threat that the flaws/areas of interest pose on the pipeline based on the stress/strain states, the flaws/shape and the position within the pipeline.

The method 200 can further include a step 250 of determining a maximum allowable operating pressure (MAOP) for the pipeline based on the one or more areas of interest. By monitoring the stresses on the specimen, in addition to the geometrical characteristics, the systems and methods described herein are capable of and methods described herein advantageously improve MAOP accuracy by removing the need to make unnecessary assumptions regarding the stresses on the specimen and the shape of the specimen at different locations. Accordingly, the systems and methods described herein provide a user with systems having an improved probability of detectability (POD) and probability of identification (POI) of stress conditions for structurally critical areas as well as a predicted and quantitative stress map which can result in more through integrity assessment and lead to fewer unnecessary repair digs (e.g., in the case of a pipeline application) and fewer accidents/mistakes in any application. In some aspects, the MAOP can be determined as a pressure that does not exceed a minimum predicted burst pressure as determined from all flaws within the pipeline. For example, at step 250, the system can be configured to further analyze the one or more areas of interest and compare them to one another in order to determine one or more critical regions. Based on the critical regions, the system can be configured to determine an maximum allowance pressure for the pipeline, as will be described in greater detail below.

Lastly, the method 200 can include a step 255 of providing the comprehensive model/representation of the pipeline, the areas of interest and/or the MOAP that are generated/determined at steps 240, 245, 250, respectively. In some aspects, the providing step 255 can include providing the comprehensive model/representation of the pipeline, the areas of interest and/or the MOAP to a user interface display that is communicatively coupled to the computing system 170 to be viewed/interacted with by a user. For example, in some aspects, the computing system 170 can be a desktop/laptop computer, smartphone having a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computing system 170, as described in greater detail below.

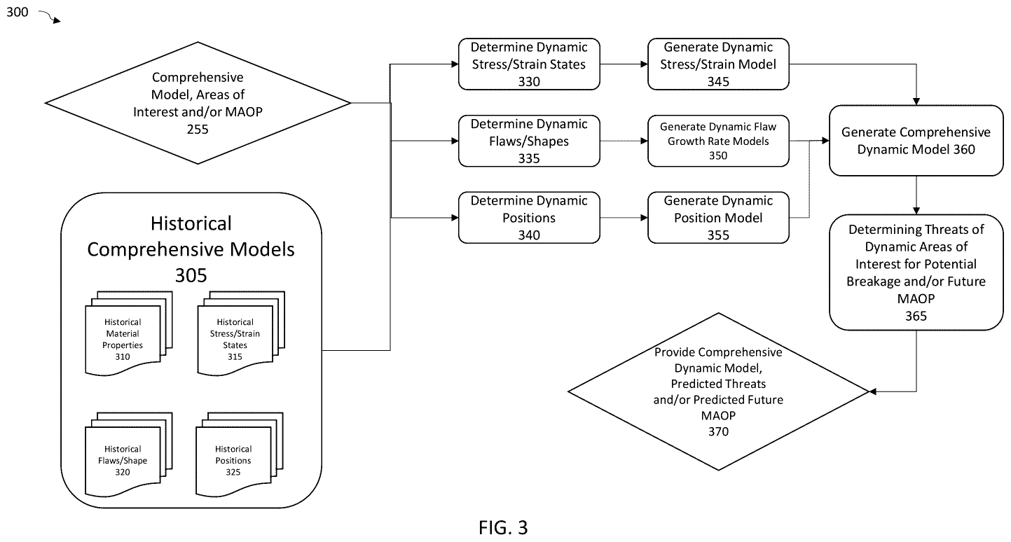

Additionally, as mentioned above, in some cases, it can be desirable to understand how the area of interest evolves over time in order to accurately predict the threat of a given area of interest within a specimen. Accordingly, FIG. 3 illustrates a dynamic method 300 of inspecting a specimen (e.g., a pipeline) over time according using the inspections systems described herein (e.g., inspection system 100 of FIG. 1). The method 300 will be described herein with reference made to the inspection system of FIG. 1 and the method 200 of FIG. 2.

In some aspects, the method 300 can use the comprehensive model, areas of interest and/or the MAOP that is provided by the system at step 255 of method 200 in unison with historical comprehensive models 305 that are stored with the memory of the system. Similar to the comprehensive model, areas of interest and/or the MAOP that is provided by the system at step 255, the historical comprehensive models 305 can include data characterizing one or more past inspections of the pipeline including historical material properties 310, historical stress/strain states, historical flaws/shapes and historical positions of the pipeline being inspected. In some aspects, the historical comprehensive models 305 can be generated and stored within the memory of the system using the same or similar method of FIG. 2.

Accordingly, in some aspects, the method 300 can proceed with steps of determining dynamic stress/strain states of the pipeline, at 330, determining dynamic changes in flaws and/or changes in shape within the pipeline, at 335, and determining dynamic changes in the positional data regarding the pipeline, at 340. The steps 330, 335, 340 can be executed by comparing the comprehensive representation provided at step 255 to the historical comprehensive models 305 to determine how the stresses, flaws, shapes, and positions of the pipeline are changing dynamically over time. In some aspects, for example, the dynamic flaw growth rate models described herein can be used for Pipeline Integrity Virtual Assessment (PIVA), as described in U.S. Pat. No. 10,895,556 B2, the entire contents of which are incorporated by reference herein.

Once the system has determined the dynamic changes in the pipeline at steps 330, 335, 340, the system can be configured to generate dynamic models of the stress/strain states, the flaw/shape growth rates and the position of the pipeline, at steps 345, 350, 355. In some aspects, the dynamic models generated at steps 345, 350, 355 can be used to generate a comprehensive dynamic model of the pipeline at step 360. Similar to the comprehensive model generated at step 240 of method 200, the comprehensive dynamic model generated at step 360 can include an overlay of the stress data, the NDE data and the positional data at the of the plurality of points being inspected. Additionally, the comprehensive dynamic model can allow for the user to intuitively visualize changes in the stresses, flaws within the pipeline and the areas in which the stresses, flaws overlap with one another and evolve over time. Further, the comprehensive dynamic model can allow for the user to intuitively visualize changes in shape and/or position of portions of the pipeline over time, which can indicate potential changes in external loading as a result of environmental factors such as geohazards (e.g., landslides, flooding, earthquakes, etc.) as described in greater detail below.

In some aspects, the method 300 can also include a step 365 of determining/predicting one or more dynamic areas of interest corresponding to one or more points along the pipeline that exhibit changes in one or more of the stress data, the geometrical flaw data and the positional data over time. In some aspects, the system can further incorporate the use of pre-determined safety factors or acceptability criteria for fitness of service in order to determine a level of potential injuriousness. For example, the one or more dynamic areas of interest determined can indicate to the user that a condition of a previous area of interest has worsened since the last inspection and may warrant further investigation and or intervention (e.g., repair/replacement). In some cases, worsening areas of interest over time can be exhibited by changes in stress/strain loads in combination with physical flaws, indicating that a flaw may be impacting the stress at that point in the pipe beyond conventional predictive assumptions, or vice versa. Accordingly, the one or more dynamic areas of interest can be used to predict threats within the pipeline, for example a potential future breakage within the pipeline based on the growth rate of an area of interest. In some aspects, the one or more dynamic areas of interest and/or the predicted threats can influence a future MAOP for the pipeline, as described in greater detail below.

The method 300 can also include a step 370 of providing the comprehensive dynamic model/representation of the pipeline, the predicted threats/dynamic areas of interest and/or the predicted future MOAP that are generated/determined at steps 360 and 365. In some aspects, the providing step 370 can include providing the comprehensive dynamic model of the pipeline, the predicted threats/dynamic areas of interest and/or the predicted future MOAP to the user interface display that is communicatively coupled to the computing system 170, similarly to as described above in reference to FIG. 2.

The methods of FIGS. 2-3 differs from traditional methods described above, in that under traditional methods, the threat of a given flaw is estimated as a geometric prediction from NDE inspection data, in isolation, which may incompletely diagnose the severity of the flaw and/or a level of potential injuriousness. For example, using the traditional method, an ambient mechanical stress field may have been assumed when, in reality, there are more complicated stresses/strains on the specimen that may go undetected that are overlapping interacting flaws within the specimen. Accordingly, the systems and methods described herein advantageously provide an efficient solution that combines time and positionally correlated stress/strain data with NDE data acquired during inspection to generate comprehensive models of the specimen being inspected. Such comprehensive models can support geohazard management programs and can more accurately identify new threat locations.

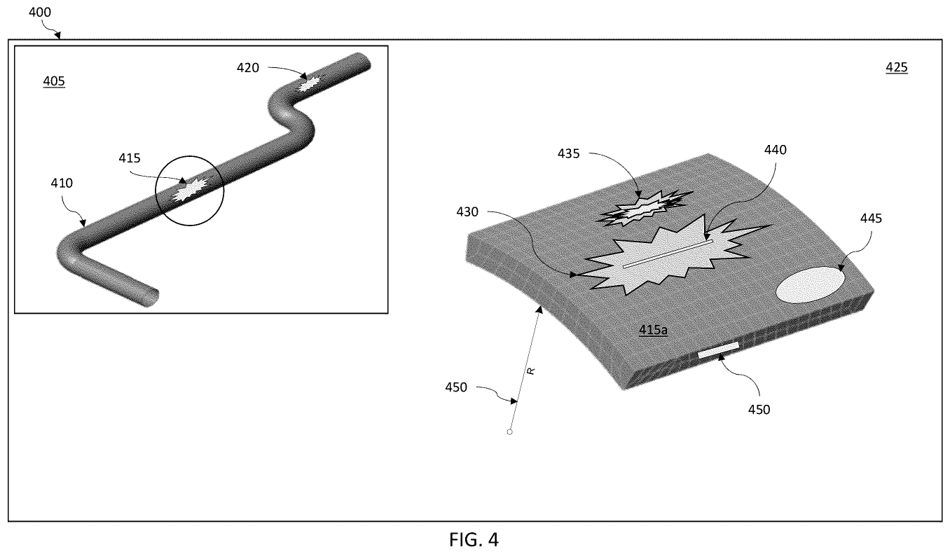

FIG. 4 is an exemplary comprehensive model/representation 400 of a specimen being inspected using the systems and methods described herein (e.g., the comprehensive models described above in reference to FIGS. 2-3). In some aspects, the comprehensive model/representation 400 can be generated such that is readable by a variety of inspection softwares configured to aid in structural engineering/design and inspection. In some aspects, the comprehensive model 400 can combine the time and position correlated data with physical principles surrounding the material properties of features on the specimen, such as welds, tees, bends, fittings, etc. to more accurately analyze the severity of any flaws detected. This provides a user with the capability to comprehensively analyze the integrity of the specimen by being capable of simultaneously considering the geometry of the specimen, the flaws on/within the specimen, and the stresses on the specimen at distinct points along, as will be discussed in greater detail below.

In some aspects, the comprehensive model 400 can be provided to the user interface display that is communicatively coupled to the computing system 170, similarly to as described above. In some aspects, the comprehensive model 400 can include a three-dimensional representation 405 of the specimen being inspected. For example, as shown in FIG. 4, the three-dimensional representation 405 is a representation of a portion of a pipeline 410 being inspected. In some aspects, the three-dimensional representation 405 can include one or more areas of interest 415, 420, which can correspond to the one or more areas of interest or dynamic areas of interest described above. The comprehensive model 400 can also include a detailed view 425 of one of the areas of interest 415, 420. For example, in some cases, the user can interact with and area of interest 415 within the three-dimensional representation 405 and the system can be configured to provide the detailed view 425 responsive to the interaction.

The detailed view 425 can provide a three-dimensional rendering 415a of a portion of the pipe wall at the selected area of interest 415 including a comprehensive overlay of the stress data, the NDE data and the positional data at the selected area of interest which can allow the user to intuitively visualize the stresses and flaws within the pipeline and the areas in which the stresses and flaws overlap. For example, the detailed view 425 can include a plurality of stresses of interest 430, 435 on the pipeline at the selected area of interest 415. In some aspects, each element of the three-dimensional rendering 415a can include its own operating point on a stress/strain curve selected based on the material of the pipe that is determined as described above. Accordingly, each element can interdepend on the operating points and the material properties of the surrounding elements. The detailed view 425 can also include a visual representation of flaws and geometrical contours of the specimen at the selected area of interest. For example, the area of interest can include a crack 440 (e.g., a point of discontinuity within the pipeline having a length and depth but no width), a point of corrosion (e.g., volumetric material loss) 445 and an internal defect 450. In some aspects, the detailed view 425 can provide an intuitive visualization of the locations and relationships between the stress data, the NDE data and the positional data at the selected area of interest. For example, as shown in the detailed view 425, the stress of interest 430 is located at the same position as the crack 440, which may produce a more critical stress than that same load on a distributed surface corrosion which can indicate to the user that that position in the pipeline may be a potential threat for breakage. Additionally, the detailed view 425 can provide a radius or shape of specimen 455 at the area of interest. In some cases, the radius or shape of specimen 455 at the area of interest can be aligned with what the expected radius of the pipe is supposed to be. However, in some cases, the radius or shape of specimen 455 at the area of interest can indicate an irregularity (e.g., a slightly oval radius, a dent, a deformation, etc.), which may warrant further investigation. In some cases, an abnormal radius can be provided as a function of the over full circumference of the pipe at that location.

Furthermore, in some cases, various impact or loading events can result in a dent in the pipe way. However, in many situations, internal pressure within the pipe can cause the dent to be pushed out and re-rounded, thus removing any visual indication of the dent. In this case, the dent may no longer be detected by geometrical NDE tools. Accordingly, in some aspects, the radius or shape of specimen 455 at the area of interest may be aligned with what the expected radius of the pipe is supposed to be, but the stress data may indicate residual stress. In this case, the system can advantageously be configured to determine that that location may have had a dent which was re-rounded back to its original shape, but may still pose a threat to the integrity of the pipeline. For example, in reference to FIG. 1, during an inspection, readings from the caliper unit 130 may determine that there is no dent present at a point in the pipe wall, but the stress measurement unit 150 may determine a residual stress at that point. In this case, the inspection system 100 can be configured to determine that that point had a dent that was re-rounded, and that point can be determined to be an area of interest which is presented to the user in the comprehensive model. In addition to being able to detect residual stress in re-rounded sections of a specimen, the systems and methods described herein are similarly capable of detecting residual stress as a result of heat affected zones (e.g., a girth weld within the pipeline). In some aspects, a re-rounded dent can also be determined by the dynamic models described herein, in a cased where a historical model shows a dent, but a more current model does not exhibit the dent.

Additionally, the systems and methods described herein are capable of providing a user with a total strain history on the specimen, from construction, and are capable of monitoring the condition of the specimen throughout its life. Furthermore, by providing comprehensive dynamic models of the pipeline over time, including axial stress as a function of axial loading, the systems and methods described herein can be used to predict a future MAOP as a result of load cycling. In some cases, a pipeline may be exposed to load cycling as a result of daily/seasonal temperature changes, or the like. Accordingly, it can be advantageous to perform inspections at different times of the day/year in order to enable load cycle detection. This can aid in prediction of the growth rate of flaws as a function of, for example, temperature related load cycles. Additionally, the systems and methods described herein can maintain a load history of the specimen in the memory thereof to aid in strain calculation.

In addition to the stress data, the NDE data and the positional data provided, the comprehensive model 400 can also include visual representations of changes in structural material properties across the specimen. In some aspects, in reference to FIG. 1, material measurements can be acquired by electromagnetic measurements sensors provided in the one or more transducer units 140 (e.g., eddy current sensors). Material properties in a pipeline may vary in different locations depending on material, design, etc. Accordingly, by including material measurements in the comprehensive model 400, the system can provide more accurate determinations of critical zones. For example, if the stress data is overlaid with corresponding material properties of the specimen, it can be determined there is an area of interest that exhibits a high level of stress, but may also exhibit a high level of toughness. In this case, that area of interest can be determined to be less critical than it would have been if the system were only accounting for stress. Alternatively, it can be determined there is an area of interest that exhibits a lower level of stress, but also exhibits a lower level of toughness. In this case, that area of interest can be determined to be a critical region in determining the MAOP for the specimen.

Additionally, in some aspects, the one or more areas of interest 415, 420 of the comprehensive model 400 can include an area of the pipe that is determined to have experienced a dynamic change in position, based on measurements acquired by an IMU of the system (e.g., IMU 160 of FIG. 1). In some cases this change in position can also coincide with a flaw (e.g., a dent or crack) or an abnormal stress profile. In this case, the system can be configured to flag this area of interest as experiencing an external load. In some cases, external loads can occur from supports that are supporting the pipeline or external loading as a result of environmental factors such as geohazards (e.g., landslides, flooding, earthquakes, etc.). Accordingly, the comprehensive model 400 can additionally provide a comprehensive model capable of identifying external loads on the specimen to more accurately identify new threat locations and make predictions about the severity and nature of identified flaws.

Accordingly, the systems and methods described herein are capable of predicting a future state of every element of the rendering 415a, and other similar renderings generated for every point along the pipeline based on baseline and growth/change models described above. This capability can aid in determining an MAOP for all points along the pipeline. Additionally, the systems and methods described herein are not only able to identify that a flaw or shape irregularity overlaps with a stress load, but the system is also capable of determining the type of flaw present, and how that flaw type is affected by the stress load. In some cases, as described above, flaws on or within the specimen can be acute flaws, like cracks, while in other cases, the flaws can be more distributed flaws, like corrosion. If a transducer unit of the system (e.g., an EMAT transducer unit 140 of FIG. 1) identifies a flaw (e.g., crack 440), and a stress measurement unit (e.g., MAPS 150 of FIG. 1) also identifies the flaw, the system can be configured to determine that that flaw is a crack. Alternatively, if the transducer unit identifies a flaw (e.g., internal defect 450), but the stress measurement unit does not, the system can be configured to determine that that flaw is an internal defect (or corrosion, or other flaw that is not identified by the stress measurement unit).

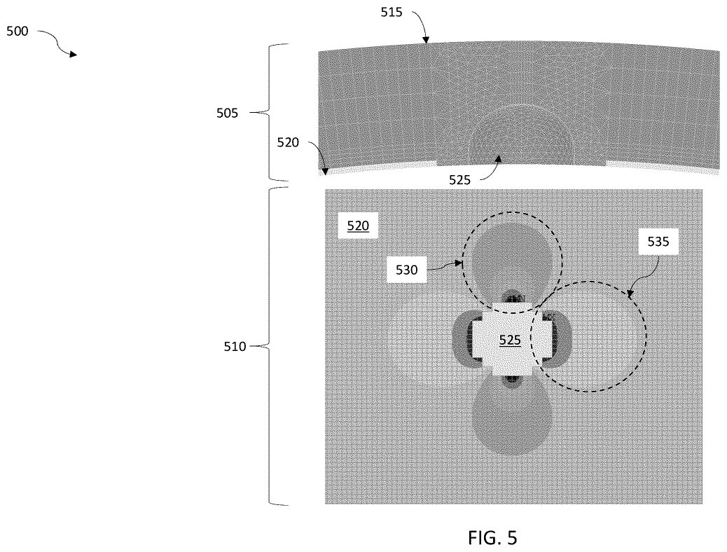

FIG. 5 illustrates exemplary renderings 505, 510 of a cross-sectional view of a section of a pipeline being inspected and an internal surface view of the section of the pipeline being inspected, respectively. As shown in FIG. 5, the renderings 505, 510 can include an external surface of the pipe 515, and an internal surface of the pipe 520. In some aspects, the renderings 505, 510 can be used, in combination with the time data, stress data, NDE data and positional data acquired by the systems and methods described herein and material properties stored within the memory of the system to determine an MAOP for a point along a specimen that includes a flaw on an internal surface thereof. As an inspection apparatus (e.g., inspection apparatus 110) performs an in-line-inspection (ILI), the apparatus can acquire direct measurements of the internal surface of the pipe. For example, as shown in FIG. 5, when the comprehensive model is generated from the inspection, renderings 505, 510 can indicate that there is a flaw 525 on the internal surface 520 the pipe wall. The system can be configured to use the stress measurements acquired around the flaw 525 to confirm and/or determine the resultant stress regions, shown as stresses 530, 535 around the flaw 525, which are projected on the rendering 510. The stresses 530, 535 can be stress/strain states along that point in the pipe as a result of, for example, the presence of the flaw 525, surrounding sources of stress including, but not limited to, residual stresses, external loading, internal pressure or any combination thereof. In some aspects, these resultant stress regions 530, 535 can be used by the system to aid in a determination of the MAOP of the specimen at that location.

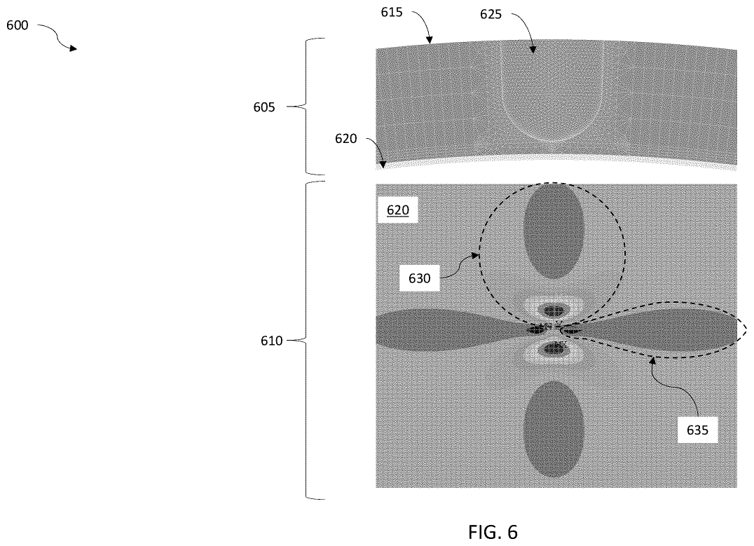

However, in some cases, a flaw (e.g., a crack) may be present on an external surface of the pipe. Accordingly, when inspecting pipelines using the in-line-inspection (ILI) systems and methods described herein, it can be advantageous to be able to determine the stress on the external surface of the pipe, without having perform a completely separate inspection of the external surface, which can be extremely cost prohibitive, or in most cases impossible. Accordingly, FIG. 6 illustrates exemplary renderings 605, 610 of a cross-sectional view of a section of a pipeline being inspected and an internal surface view of the section of the pipeline being inspected, respectively. As shown in FIG. 6, the renderings 605, 610 can include an external surface of the pipe 615, and an internal surface of the pipe 620. In some aspects, the renderings 605, 610 can be used, in combination with the time, stress, geometrical and positional data acquired by the systems and methods described herein, material properties stored within the memory of the system and predictive models stored within the memory to determine that an external flaw (e.g., flaw 625) is present and a location of that flaw. For example, the system can be configured to use the stress measurements acquired along the internal surface 620 of the pipe, around the flaw 625, to confirm and/or determine the resultant stress regions, shown as stresses 630, 635 internal of the flaw 625, which are projected on the rendering 610. The stresses 630, 635 can be stress/strain states along that point in the pipe as a result of, for example, the presence of the flaw 625, surrounding sources of stress including, but not limited to, residual stresses, external loading, internal pressure or any combination thereof. In some aspects, the system can use the predictive models to determine that there is a flaw 625 on an external surface of the pipe at that location, as that point demonstrates an acute maximum stress/strain state at that location. Additionally, in some aspects, these resultant stress regions 630, 635 can be further used by the system to determine an approximate stress on the external surface 615. Further, the resultant stress regions 630, 635 and/or the approximate stress on the external surface 615 can be used, along with the time data, NDE data, positional data, material properties and predictive models to determine an MAOP that location. In some aspects, the predictive models can include components of finite element analysis (FEA), mathematical models, lab tests, or any combination thereof.

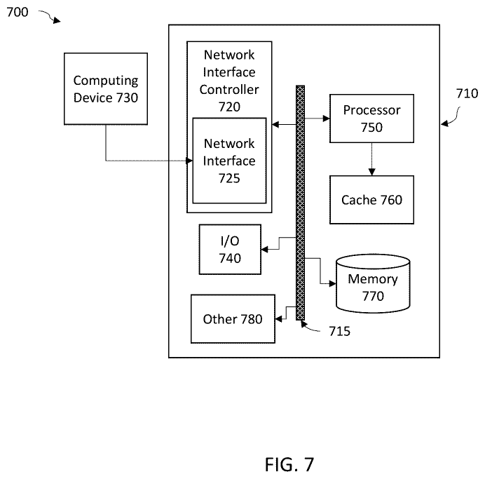

FIG. 7 is a block diagram 700 of a computing system 710 suitable for use in implementing the computerized components described herein, such as the computing system provided in the hub 114 of the inspection apparatus 110 and/or the computing system 170. In broad overview, the computing system 1010 includes at least one processor 1050 for performing actions in accordance with instructions, and one or more memory devices 760 and/or 770 for storing instructions and data. The illustrated example computing system 710 includes one or more processors 750 in communication, via a bus 715, with memory 770 and with at least one network interface controller 720 with a network interface 725 for connecting to external devices 730, e.g., a computing device. The one or more processors 750 are also in communication, via the bus 715, with each other and with any I/O devices 730 at one or more I/O interfaces 730, and any other devices 780. The processor 750 illustrated incorporates, or is directly connected to, cache memory 760. Generally, a processor will execute instructions received from memory. In some aspects, the computing system 710 can be configured within a cloud computing environment, a virtual or containerized computing environment, and/or a web-based microservices environment.

In more detail, the processor 750 can be any logic circuitry that processes instructions, e.g., instructions fetched from the memory 770 or cache 760. In many aspects, the processor 750 is an embedded processor, a microprocessor unit or special purpose processor. The computing system 710 can be based on any processor, e.g., suitable digital signal processor (DSP), or set of processors, capable of operating as described herein. In some aspects, the processor 750 can be a single core or multi-core processor. In some aspects, the processor 750 can be composed of multiple processors.

The memory 770 can be any device suitable for storing computer readable data. The memory 770 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 710 can have any number of memory devices 770.

The cache memory 760 is generally a form of high-speed computer memory placed in close proximity to the processor 750 for fast read/write times. In some implementations, the cache memory 760 is part of, or on the same chip as, the processor 750.

The network interface controller 720 manages data exchanges via the network interface 725. The network interface controller 720 handles the physical, media access control, and data link layers of the Open Systems Interconnect (OSI) model for network communication. In some implementations, some of the network interface controller's tasks are handled by the processor 750. In some implementations, the network interface controller 720 is part of the processor 750. In some implementations, a computing device 710 has multiple network interface controllers 720. In some implementations, the network interface 725 is a connection point for a physical network link, e.g., an RJ 45 connector. In some implementations, the network interface controller 720 supports wireless network connections via network interface port 725. Generally, a computing device 710 exchanges data with other network devices 730, such as computing device 730, via physical or wireless links to a network interface 725. In some implementations, the network interface controller 720 implements a network protocol such as LTE, TCP/IP Ethernet, IEEE 802.11, IEEE 802.16, or the like.

The other computing devices 730 are connected to the computing device 710 via a network interface port 725. The other computing device 730 can be a peer computing device, a network device, or any other computing device with network functionality. For example, a computing device 730 can be a remote controller, or a remote display device configured to communicate and operate the inspection apparatus 110 remotely. However, it should be noted that the inspection apparatus 110 can also be operated/navigated autonomously. In some aspects, a computing device 730 can include a server or a network device such as a hub, a bridge, a switch, or a router, connecting the computing device 710 to a data network such as the Internet.

In some uses, the I/O interface 730 supports an input device and/or an output device (not shown). In some uses, the input device and the output device are integrated into the same hardware, e.g., as in a touch screen. In some uses, such as in a server context, there is no I/O interface 730 or the I/O interface 730 is not used. In some uses, additional other components 780 are in communication with the computer system 710, e.g., external devices connected via a universal serial bus (USB).

The other devices 780 can include an I/O interface 740, external serial device ports, and any additional co-processors. For example, a computing system 710 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 710, e.g., a touch screen on a tablet device. In some implementations, a computing device 710 includes an additional device 780 such as a co-processor, e.g., a math co-processor that can assist the processor 750 with high precision or complex calculations.

Certain exemplary aspects have been described to provide an overall understanding of the principles of the structure, function, manufacture, and use of the systems, devices, and methods disclosed herein. One or more examples of these aspects have been illustrated in the accompanying drawings. Those skilled in the art will understand that the systems, devices, and methods specifically described herein and illustrated in the accompanying drawings are non-limiting exemplary aspects and that the scope of the present invention is defined solely by the claims. The features illustrated or described in connection with one exemplary embodiment may be combined with the features of other aspects. Such modifications and variations are intended to be included within the scope of the present invention. Further, in the present disclosure, like-named components of the aspects generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described aspects. Accordingly, the present application is not to be limited by what has been particularly shown and described, except as indicated by the appended claims. All publications and references cited herein are expressly incorporated by reference in their entirety.

1. An inspection system comprising:
an inspection apparatus configured to inspect a specimen, the inspection apparatus comprising a plurality of non-destructive examination (NDE) units configured to acquire at least stress data characterizing stress on the specimen at a plurality of points along the specimen, NDE data characterizing flaws within the specimen and dimensional properties of the specimen at the plurality of points along the specimen and positional data characterizing a location of the plurality of points along the specimen; and
a computing system including at least one data processor and a memory storing computer-readable instructions which, when executed by the at least one data processor, cause the at least one data processor to perform operations comprising:
receiving, from the inspection apparatus, the stress data, the NDE data and the positional data;
generating a comprehensive representation of the specimen, wherein the comprehensive representation comprises an overlay of the stress data, the NDE data and the positional data at the of the plurality of points; and
providing the comprehensive representation to a user interface display communicatively coupled to the computing system.

2. The inspection system of claim 1, wherein the specimen is a pipeline made from a ferromagnetic material.

3. The inspection system of claim 2, wherein the plurality of NDE units comprise a stress measurement unit including a plurality of magnetic probes and the stress data comprises stress measurements acquired at a plurality of angles for each of the plurality of points along the specimen.

4. The inspection system of claim 3, wherein the flaws include defects, areas of volumetric material loss, cracks and dents within the pipeline and the dimensional properties include a shape of the pipeline at the plurality of points, and wherein the NDE data further includes data characterizing localized materials properties of the pipeline.

5. The inspection system of claim 4, wherein the plurality of NDE units further comprise one or more of an ultrasonic transducer unit, a radiography unit, an electromagnetic acoustic transducer (EMAT) unit, an eddy current probe unit, a magnetic flux leakage (MFL) unit, a caliper unit, a camera unit, an encoder unit and an inertial measurement unit (IMU).

6. The inspection system of claim 4, wherein the positional data includes first positional data, acquired by the encoder unit, and characterizing a position of the plurality of points within the pipeline and second positional data, acquired by the IMU, and characterizing a position of the plurality of points in three-dimensional space.

7. The inspection system of claim 2, wherein the operations performed by the at least one data processor further comprise:
determining one or more areas of interest within the pipeline based on the comprehensive representation, wherein the one or more areas of interest correspond to one or more points of the plurality of points that exhibit one or more of a high stress or a flaw; and
providing the one or more areas of interest to the user interface display.

8. The inspection system of claim 7, wherein the operations performed by the at least one data processor further comprise:
determining one or more maximum allowable operating pressures for the pipeline based on the one or more areas of interest; and
providing the one or more maximum allowable operating pressures to the user interface display.

9. The inspection system of claim 2, wherein the memory further stores historical data characterizing one or more past inspections of the pipeline and the operations performed by the at least one data processor further comprise:
comparing the comprehensive representation to the historical data;
determining one or more dynamic areas of interest within the pipeline based on the comparison, wherein the one or more dynamic areas of interest correspond to one or more points of the plurality of points along the pipeline that exhibit changes in one or more of the stress data, the NDE data and the positional data over time; and
providing the one or more dynamic areas of interest to the user interface display.

10. The inspection system of claim 9, wherein the operations performed by the at least one data processor further comprise:
predicting one or more future maximum allowable operating pressures for the pipeline for a given point in time based on the one or more dynamic areas of interest; and
providing the one or more future maximum allowable operating pressures to the user interface display.

11. The inspection system of claim 9, wherein the operations performed by the at least one data processor further comprise:
determining a potential geohazard threat based on the one or more dynamic areas of interest, wherein the potential geohazard threat is determined based on changes in the positional data over time; and
providing a notification to the user interface display indicative of the potential geohazard threat and the positional data corresponding to the potential geohazard.

12. The inspection system of claim 2, wherein the inspection apparatus is an in-line inspection unit configured to move along the pipeline during the inspection.

13. A method comprising:
receiving, by a computing system including at least one data processor and a memory storing computer-readable instructions, from an inspection apparatus, stress data characterizing stress at a plurality of points of a specimen being inspected, non-destructive examination (NDE) data characterizing flaws within the specimen and dimensional properties of the specimen at the plurality of points and positional data characterizing a location of the plurality of points the specimen;
generating, by the at least one data processor, a comprehensive representation of the specimen, wherein the comprehensive representation comprises an overlay of the stress data, the NDE data and the positional data at the of the plurality of points; and
providing, by the at least one data processor, the comprehensive representation to a user interface display communicatively coupled to the computing system.

14. The method of claim 12, wherein the specimen is a pipeline made from a ferromagnetic material and the inspection apparatus is an in-line inspection unit, the method further comprising deploying the in-line inspection unit within the pipeline to perform the inspection.

15. The method of claim 14, wherein the in-line inspection unit comprises:
a stress measurement unit configured to acquire the stress data; and
one or more NDE units configured to acquire the NDE data and the positional data.

16. The method of claim 15, wherein one or more NDE measurement units include one or more of an ultrasonic transducer unit, a radiography unit, an electromagnetic acoustic transducer (EMAT) unit, an eddy current probe unit, a magnetic flux leakage (MFL) unit, a caliper unit and a camera unit, and the flaws include one or more of defects, areas of volumetric material loss, cracks and dents within the pipeline and the dimensional properties include a shape of the pipeline at the plurality of points, and wherein the NDE data further includes data characterizing localized materials properties of the pipeline.

17. The method of claim 16, wherein one or more NDE measurement units include an encoder and an inertial measurement unit (IMU), the method further comprising:
acquiring, by the encoder, first positional data characterizing a position of the plurality of points within the pipeline; and
acquiring, by the IMU, second positional data characterizing a position of the plurality of points in three-dimensional space.

18. The method of claim 12, further comprising:
determining, by the at least one data processor, one or more areas of interest within the pipeline based on the comprehensive representation, wherein the one or more areas of interest correspond to one or more points of the plurality of points that exhibit one or more of a high stress or a flaw; and
providing, by the at least one data processor, the one or more areas of interest to the user interface display.

19. The method of claim 18, further comprising:
determining, by the at least one data processor, one or more maximum allowable operating pressures for the pipeline based on the one or more areas of interest; and
providing, by the at least one data processor, the one or more maximum allowable operating pressures to the user interface display.

20. The method of claim 12, wherein the memory further stores historical data characterizing one or more past inspections of the pipeline, the method further comprising:
comparing, by the at least one data processor, the comprehensive representation to the historical data;
determining, by the at least one data processor, one or more dynamic areas of interest within the pipeline based on the comparison, wherein the one or more dynamic areas of interest correspond to one or more points of the plurality of points along the pipeline that exhibit changes in one or more of the stress data, the NDE data and the positional data over time; and
providing, by the at least one data processor, the one or more dynamic areas of interest to the user interface display.

21. The method of claim 20, further comprising:
predicting, by the at least one data processor, one or more future maximum allowable operating pressures for the pipeline for a given point in time based on the one or more dynamic areas of interest; and
providing, by the at least one data processor, the one or more future maximum allowable operating pressures to the user interface display.

22. The method of claim 20, further comprising:
determining, by the at least one data processor, a potential geohazard threat based on the one or more dynamic areas of interest, wherein the potential geohazard threat is determined based on changes in the positional data over time; and
providing, by the at least one data processor a notification to the user interface display indicative of the potential geohazard threat and the positional data corresponding to the potential geohazard.
